(19) United States
(12) Patent Application Publication
(10) Pub. No.: US 2013/0085975 A1
(43) Pub. Date: Apr. 4, 2013

(54) Device for Monitoring the Lateral Environment of a Vehicle

(71) Applicants: Matthias Marcus Wellhoefer, Stuttgart (DE); Stephan Zwerschke, Stuttgart (DE)

(72) Inventors: Matthias Marcus Wellhoefer, Stuttgart (DE); Stephan Zwerschke, Stuttgart (DE)

(21) Appl. No.: 13/639,435

(22) PCT Filed: Jun. 6, 2011
(86) PCT No.: PCT/EP11/59263

§ 371 Date: Dec. 17, 2012

(30) Foreign Application Priority Data
Jun. 8, 2010 (DE) 10 2010 029 780.1

(51) Int. Cl. G06N 5/02

(52) U.S. Cl. CPC G06N 5/022
USPC 706/46

(57) ABSTRACT

A device for monitoring the lateral environment of a vehicle. The device includes an evaluation and control unit and at least one predictive sensor unit. The evaluation and control unit have at least one interface, which receives signals from the at least one predictive sensor unit, and an arithmetic unit which is coupled to the at least one interface and analyses signals from the at least one predictive sensor unit for detecting an object in a lateral monitoring region and for determining information about the detected object. The at least one predictive sensor unit is a low-cost sensor unit, and at least two predictive sensor units, which have overlapping monitoring regions, are disposed at a distance from each other on each vehicle side.

### FIELD OF THE INVENTION

The present invention relates to a device for monitoring the lateral environment of a vehicle.

### BACKGROUND INFORMATION

Conventional devices for monitoring the environment of a vehicle predominantly provide coverage of the frontal region and/or a slight front/side coverage. A multitude of relatively expensive environment sensors such as radar, ultrasound, stereo/mono video cameras, laser scanners, and PDM (Photon Multiplexing Devices) are installed for this purpose. For comfort functions as well, such as adaptive cruise control (longitudinal control, ACC), forward collision warning (FCW), blind spot detection (BSD), cross traffic alert (CTA), lane-keeping support (LKS), urban area/city safety, lane-departure warning (LDW) or parking aids, a multitude of expensive environment sensors are installed in the vehicle. The required sensors for the particular functions typically differ substantially with regard to the requirements, such as range, opening angle, sensor data rate, etc., so that a vehicle provided with a plurality of functions from the field of active and passive safety is equipped with a plurality of sensors.

U.S. Published Patent Application No. US 2004/0183281 A1, for instance, describes a device for lateral monitoring of the environment of a vehicle equipped with an evaluation and control unit and at least one predictive sensor unit. The evaluation and control unit in this case receives signals from the at least one predictive sensor unit and analyses them in order to detect an object in a lateral monitoring region and to determine information in connection with the detected object. To improve the information about detected objects, the evaluation and control unit additionally analyses information from a further sensor unit, which detects lateral yawing motions of the vehicle.

### SUMMARY

An example device according to the present invention for monitoring the lateral environment of a vehicle may have the advantage that a low-cost sensor system having a plurality of sensor units is defined, which is able to supply a plurality of passive and active vehicle safety functions and/or driver-assistance functions with information about objects in the lateral vehicle environment. Specific developments of the present invention advantageously satisfy the requirements regarding data rate and/or monitoring ranges. However, one advantage of the present invention is costs, because the sensor units of the device according to the present invention cost about as much as a single laser scanner and thus are also much less expensive than a stereo camera or a long- or mid-range radar system.

An example device according to the present invention for monitoring the lateral environment of a vehicle includes an evaluation and control unit and at least one predictive sensor unit. The evaluation and control unit has at least one interface, which receives signals from the at least one predictive sensor unit, and an arithmetic unit which is coupled to the at least one interface and analyses signals from the at least one predictive sensor unit for detecting an object in a lateral monitoring region and for determining information about the detected object. According to the present invention, the at least one predictive sensor unit is developed as low-cost sensor unit; at least two predictive sensor units, which have overlapping monitoring regions and are disposed at a distance from each other, are situated on each vehicle side.

In the case at hand, the evaluation and control unit may be an electrical device such as a control unit, especially an airbag control unit, which processes and analyzes recorded sensor signals. The evaluation and control unit may have at least one interface, which is implementable as hardware and/or software. In a hardware design, for instance, the interfaces may be part of a so-called system ASIC which features the most varied functions of the evaluation and control unit. However, it is also possible for the interfaces to be separate, integrated switching circuits or to be at least partially made up of discrete components. In a software design the interfaces may be software modules which are present on a microcontroller in addition to other software modules, for example. A computer program product which has program code stored on a machine-readable medium such as a semiconductor memory, a hard-disk memory or an optical memory, and which is used for implementing the analysis when the program is executed on an evaluation and control unit, is also advantageous.

It is especially advantageous that the at least one predictive sensor unit has a range of approximately 2 to 10 m and/or a wide opening angle in the range of 120 to 170° and/or is able to be scanned at a data rate of approximately 1 to 2 kHz. Preferably, the at least one predictive sensor unit is implemented as cost-effective single-chip radar sensor. One predictive sensor unit is then disposed on each vehicle side, in the region of the C-column, and one predictive sensor unit is situated in the region of the A-column. This, in conjunction with the selected angular range of the opening and/or the selected range of the sensor units, ensures overlapping monitoring regions in the lateral vehicle environment, so that reliable object detection is ensured for the subsequent vehicle safety functions or driver-assistance functions.

In one advantageous development of the present invention, the arithmetic unit calculates the position and/or the distance and/or the speed of approach in relation to the vehicle for each object detected in the lateral monitoring regions, and then makes this information available.

In a further advantageous refinement of the present invention, the evaluation and control unit outputs the information about the detected objects calculated by the arithmetic unit to at least one vehicle safety system and/or at least one driver-assistance system via at least one additional interface. The information about detected objects output by the evaluation and control unit to at least one vehicle safety system may be used, for instance, for preconditioning a lateral airbag algorithm, i.e., either the early lowering of the trigger thresholds or an early plausibility check prior to contact on the basis of the sensor information, and/or for triggering a reversible and/or irreversible actuator of a passenger-protection system such as the activation of a reversible belt tightener, an active pneumatic or hydraulic seat, and/or for activating a reversible and/or irreversible adaptive vehicle structure such as, for example, inflatable hollow tubes, in order to replace massive reinforcement elements in the door for the purpose of saving weight.

In one further advantageous development of the present invention, the information about detected objects output by the evaluation and control unit to at least one vehicle safety system may be used for monitoring the blind spot and/or for detecting objects crossing from the side. For instance, the information may be used for detecting objects in the blind spot at speeds above 60 km/h, and also when turning in the standing region at speeds in the range from 0 to 60 km/h. Within city limits, bicyclists and pedestrians, in particular, must be detectable. In both applications, the sensor system also monitors whether objects arrive in the blind spot from behind, and whether an object is indeed located in this region on the side. By detecting laterally crossing objects in the rear region, it is possible to output a warning, especially when backing out of a parking space, in the event that a vehicle crosses from the side.

In one further advantageous development of the present invention, the information about the detected objects output to at least one driver-assistance system by the evaluation and control unit may be used for centering the vehicle between two detected objects during a parking operation and/or when traveling along a narrowed road section. Centering of the vehicle between two detected objects, for instance, is accomplished by outputting corrective instructions to the driver, e.g., by steering arrows on a display, or by an automatic steering intervention if the steering system is linked. When backing into a parking space, the lateral sensor units in the rear are able to measure and output the distance on the sides, for example. When the road lanes are narrower, e.g., at construction sites, or in dense highway travel, all four sensor units may be employed in order to determine the distance with respect to lateral objects at high speeds and to output corresponding corrective suggestions or to provide steering assistance.

In one further advantageous development of the present invention, the information about the detected objects output to at least one driver-assistance system by the evaluation and control unit may be used for implementing a door- and/or flap opening function. By outputting a warning, the user is then able to be warned when objects are detected in the opening region of a vehicle door, and/or the opening of a door is able to be blocked. For example, if a door is already open in an adjacent parking space, so that the room behind the door is insufficient, a warning may be output in a first stage, and the door may be locked in a second stage in an effort to avoid minor damage. The door is able to be released again as soon as the obstacle has disappeared. Furthermore, the door may be blocked for a short period of time if a slow vehicle or a bicycle is approaching from behind, in an effort to avoid minor damage or to prevent a bicyclist from falling if an inattentive driver suddenly opens a door. In addition, a door/flap of the fuel tank may be opened automatically when a movement of the fuel nozzle in the direction of the fuel tank flap is detected.

Advantageous specific embodiments of the present invention are depicted in the figures and described below. In the figures, identical reference symbols indicate components or elements that perform identical or analogous functions.

### BRIEF DESCRIPTION OF THE DRAWINGS

FIG. 1 shows a schematic plan view of a vehicle having an exemplary embodiment of a device according to the present invention for lateral monitoring of a vehicle environment.

FIG. 2 shows a schematic plan view of a vehicle having an additional exemplary embodiment of the device according to the present invention for lateral monitoring of a vehicle environment.

FIG. 3 shows a schematic plan view of a vehicle having an additional exemplary embodiment of the device according to the present invention for lateral monitoring of a vehicle environment.

FIG. 4 shows a schematic plan view of a vehicle having an exemplary embodiment of the device according to the present invention for lateral monitoring of a vehicle environment, during a reverse parking operation.

FIG. 5 shows a schematic plan view of a vehicle having an exemplary embodiment of the device according to the present invention for lateral monitoring of a vehicle environment, while traveling along a narrowed road section.

### DETAILED DESCRIPTION OF EXAMPLE EMBODIMENTS

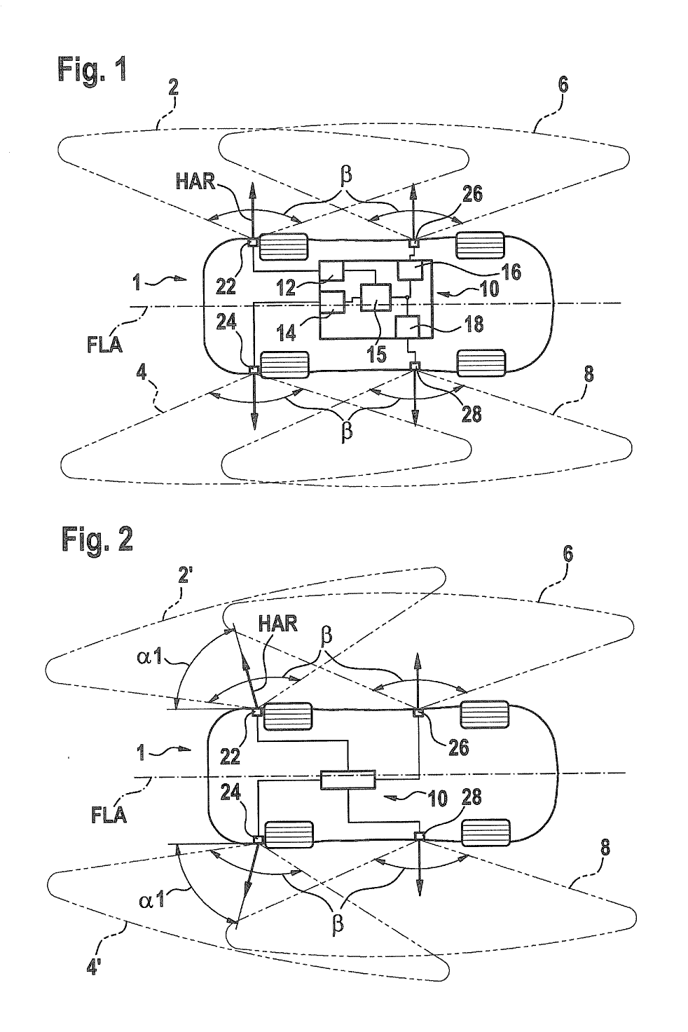

FIGS. 1 through 5 show a motor vehicle 1 having an example device according to the present invention for monitoring the lateral environment of a vehicle, which includes an evaluation and control unit 10 and a plurality of predictive sensor units 22, 24, 26, 28. Evaluation and control unit 10 has at least one interface 12, 14, 16, 18, which receives signals from the at least one predictive sensor unit 22, 24, 26, 28; it also has an arithmetic unit 15, which is coupled to the at least one interface 12, 14, 16, 18 and analyzes signals from the at least one predictive sensor unit 22, 24, 26, 28 for detecting an object H1, H2, H3 in a lateral monitoring region 2, 4, 6, 8, and for determining information about detected object H1, H2 H3.

According to the present invention, predictive sensor units 22, 24, 26, 28 are implemented as low-cost sensor units, e.g., in the form of single-chip radar sensors. At least two predictive sensor units 22, 24, 26, 28 are disposed on each vehicle side, set apart from each other, with overlapping monitoring regions 2, 4, 6, 8. Each predictive sensor unit 22, 24, 26, 28 has a range of approximately 2 to 10 m in the exemplary embodiment shown, and a wide opening angle β in the region of 120 bis 170°, and is scanned at a data rate of approximately 1 to 2 kHz. Predictive sensor units 22, 24, 26, 28 implemented as single-chip radar sensors are disposed on each side of the vehicle, in the region of the C-column and in the region of the A-column. For example, predictive sensor units 22, 24 are situated in the lateral vehicle region in the rear, in the area of the C-columns, and predictive sensor units 26, 28 are installed in the lateral vehicle region in the front, in the area of the A-columns. The different exemplary embodiments of the device according to the present invention, shown in FIGS. 1 through 3, for monitoring the lateral environment of a vehicle 1 differ in the orientation of predictive sensor units 22, 24, 26, 28.

As is also clear from FIG. 1, in the exemplary embodiment illustrated all predictive sensor units 22, 24, 26, 28 are situated in such a way that the main recording directions HAR of predictive sensor units 22, 24, 26, 28 are aligned perpendicular to longitudinal vehicle axis FLA. The illustrated lateral overlapping monitoring regions 2, 4, 6, 8 thus result for the four predictive sensor units 22, 24, 26, 28.

As can furthermore be gathered from FIG. 2, in the illustrated exemplary embodiment the two rear predictive sensor units 22, 24 are situated in such a way that their main recording directions HAR are inclined at a specifiable angle α1 toward the rear in relation to longitudinal vehicle axis FLA. The two front predictive sensor units 22, 24, 26, 28 are situated in the same way as in the exemplary embodiment according to FIG. 1, such that their main recording directions HAR are aligned perpendicular to longitudinal vehicle axis FLA. The illustrated lateral overlapping monitoring regions 2′, 4′, 6′, 8′ thus result for the four predictive sensor units 22, 24, 26, 28.

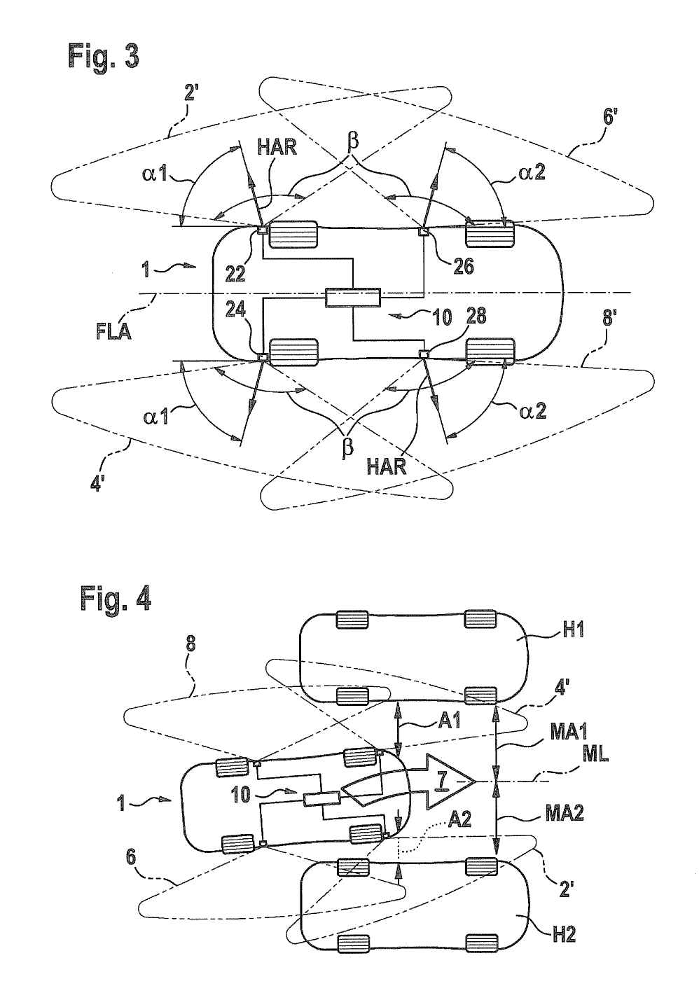

Moreover, as can be gathered from FIG. 3, the two rear predictive sensor units 22, 24 in the exemplary embodiment illustrated are positioned analogous to the exemplary embodiment in FIG. 2, such that their main recording directions HAR are inclined at a specifiable angle α1 toward the rear in relation to longitudinal vehicle axis FLA. In contrast, the two front predictive sensor units 22, 24, 26, 28 are disposed in such a way that their main recording directions HAR are inclined at a specifiable angle α2 in the forward direction in relation to longitudinal vehicle axis FLA. Therefore, illustrated overlapping lateral monitoring regions 2′, 4′, 6′, 8′ result for the four predictive sensor units 22, 24, 26, 28.

During vehicle operation, arithmetic unit 15 calculates, for instance, the position and/or distance A1, A2, A31, A32, and/or the speed of approach in relation to vehicle 1 for each object H1, H2, H3 detected in lateral monitoring regions 2, 2′, 4, 4′, 6, 6′, 8, 8′. Evaluation and control unit 10 outputs the information about detected objects H1, H2, H3 calculated by arithmetic unit 15 via at least one further interface (not shown) to at least one vehicle safety system and/or at least one driver-assistance system.

The calculated information, for instance, may be used for preconditioning a lateral airbag algorithm, i.e., either the early lowering of the trigger thresholds or an early plausibility check prior to contact on the basis of the sensor information; for triggering a reversible actuator prior to contact in a looming side crash, e.g., activation of a reversible belt tightener, an active pneumatic or hydraulic seat, etc.; for activating a reversible or irreversible adaptive vehicle structure, e.g., inflatable hollow tubes in order to replace the massive reinforcement elements in the door so as to save weight; for activating an irreversible actuator toward the side at the instant of contact or before, e.g., a super-coupling airbag which must already be fully inflated at contact. In addition, the calculated information may be used for detecting objects in the blind spot at speeds above 60 km/h and for detecting objects in the blind spot, especially bicycle riders, when turning in the standing area at speeds in the range between 0 to 60 km/h, and for detecting objects crossing from the side in the rear region of the vehicle.

Moreover, the information about detected objects H1, H2, H3 output to at least one driver-assistance system by evaluation and control unit (10) may be used for implementing a door- and/or flap opening function. In such a case, a warning may be output to the user and/or the door opening may be blocked when objects are detected in the opening region of a vehicle door. Furthermore, a fuel tank flap may be opened automatically when a movement of a fuel nozzle in the direction of the fuel tank flap is detected.

FIG. 4 shows a basic diagram of a function for automatic centering assistance when parking in reverse. To support this function, the rear lateral sensor units 22, 24 measure the lateral distance A1, A2 to vehicles H1, H2, and the centering-assistance function provides either corrective information to the driver, e.g., in the form of a steering arrow on a display, or it even assists through the steering system itself; for this to be possible, the centering assistance function must be networked with the steering system of vehicle 1. In the illustration according to FIG. 4, a solid-line arrow A1 indicates that there is still sufficient distance from first detected vehicle H1, while the dotted arrow A2 indicates that the distance to second detected vehicle H2 is very small and a steering correction in a direction indicated by bold arrow 7 is necessary. These arrows may be displayed in different colors on the display in order to enhance the warning effect. Furthermore, using the calculated distances A1, A2 with respect to detected vehicles H1, H2, it is possible to calculate their distances relative to each other, and to use this information to calculate their distance MA1 and MA2 in relation to an ideal center line ML. Distances MA1, MA2 and center line ML may be displayed as well, as an aid. Longitudinal vehicle axis FLA of own vehicle 1 may then be aligned along the ideal center line between both vehicles H1 and H2 during the parking operation.

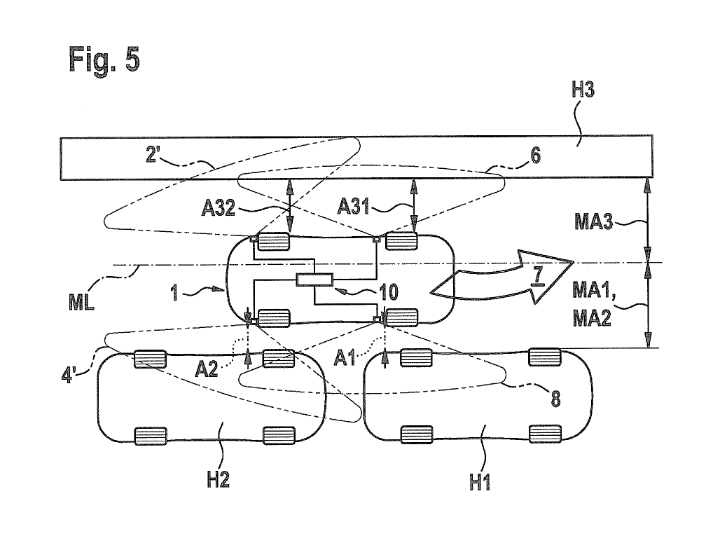

FIG. 5 shows a basic diagram of a function for automatic centering assistance when driving on a narrow road section. To assist this function, all lateral sensor units 22, 24, 26, 28 measure lateral distance A1, A2 to vehicles H1, H2 and lateral distance A31, A32 to obstacle H3, in this case, a construction site boundary, for instance. Here, too, the centering assistance function either provides the driver with corrective information or assists in centering the vehicle between obstacles H1, H2 and H3, via an intervention in the steering system. In the illustration according to FIG. 5, solid-line arrows A31, A32 indicate that sufficient distance still exists from detected obstacle H3, while the dotted arrows A1, A2 indicate that the distance to first and second detected vehicles H1, H2 is very small and a steering correction in a direction indicated by bold arrow 7 is necessary. These arrows may also be displayed in different colors on the display in order to enhance the warning effect. Furthermore, using the calculated distances A1, A2, A31, A32 to detected obstacles H1, H2, H3, it is possible to calculate their distances relative to each other, and to calculate therefrom their distance MA1, MA2 and MA3 in relation to ideal center line ML. Distances MA1, MA2, MA3 and center line ML may be displayed as well, as an aid. Longitudinal vehicle axis FLA of own vehicle 1 may then be aligned along the ideal center line between both vehicles H1 and H2, H3 when traveling along the narrow road section.

1-10. (canceled)

11. A device for monitoring a lateral environment of a vehicle, comprising:
at least one predictive sensor: and
an evaluation and control unit, the evaluation and control unit including at least one interface which receives signals from the at least one predictive sensor unit, and an arithmetic unit which is coupled to the at least one interface and analyzes signals from the at least one predictive sensor unit for detecting an object in a lateral monitoring region and for determining information about the detected object;
wherein the at least one predictive sensor unit is a low-cost sensor unit, and at least two predictive sensor units are situated on each vehicle side at a distance from each other and have overlapping monitoring regions.

12. The device as recited in claim 11, wherein the at least one predictive sensor unit at least one of: i) has a range of approximately 2 to 10 m, ii) has a wide opening angle in a range of 120 to 170°, and iii) is able to be scanned at a data rate of approximately 1 to 2 kHz.

13. The device as recited in claim 11, wherein each of the at least one predictive sensor units is a single-chip radar sensor, and one predictive sensor unit is disposed on each vehicle side in a region of a C-column of the vehicle, and one predictive sensor unit is disposed in a region of an A-column of the vehicle.

14. The device as recited in claim 11, wherein the arithmetic unit is configured to calculate for each object detected in the lateral monitoring regions at least one of a position, distance, and speed of approach in relation to the vehicle.

15. The device as recited in claim 11, wherein the evaluation and control unit is configured to output information about the detected objects output by the arithmetic unit via at least one further interface to at least one of at least one vehicle safety system, and at least one driver-assistance system.

16. The device as recited in claim 15, wherein the information about detected objects output by the evaluation and control device to at least one vehicle safety system is usable at least one of for preconditioning a lateral airbag algorithm, for triggering an actuator of a passenger protection system, for activating an adaptive vehicle structure.

17. The device as recited in claim 15, wherein the information about detected objects output by the evaluation and control unit to at least one vehicle safety system is usable one of for monitoring a blind spot, and for detecting objects crossing from the side.

18. The device as recited in claim 15, wherein the information about the detected objects output to at least one driver assistance system by the evaluation and control unit is usable at least one of: i) for centering the vehicle between two detected objects during a parking operation, and ii) when traveling on a narrow road section.

19. The device as recited in claim 18, wherein the centering of the vehicle between two detected objects takes place one of by outputting corrective information to the driver, or by an automatic steering intervention.

20. The device as recited in claim 15, wherein the information with regard to the detected objects output by the evaluation and control unit to at least one driver-assistance system may be used for implementing at least one of a door and flap opening function.
